(19) United States
(12) Patent Application Publication
(10) Pub. No.: US 2025/0022047 A1
(43) Pub. Date: Jan. 16, 2025

(54) Systems and Methods for Optimal Bidding in Repeated Online First-Price Auctions

(71) Applicant: Cognitiv Corp., New York, NY (US)

(72) Inventors: Aaron Andalman, Berkeley, CA (US); Ram Deepak Gottapu, Walnut Creek, CA (US)

(21) Appl. No.: 18/766,081

(22) Filed: Jul. 8, 2024

Related U.S. Application Data
(60) Provisional application No. 63/525,795, filed on Jul. 10, 2023.

(51) Int. Cl. G06Q 30/08

(52) U.S. Cl. CPC G06Q 30/08

(57) ABSTRACT

Systems, apparatuses, and methods for determining an optimal bidding strategy that outperforms bid shading in situations that involve repeated bids into first-price auctions. An approach termed Inventory Forecasting is developed, that functions to convert the online real-time repeating auction scenario into a problem that can be optimized offline. Inventory forecasting summarizes auctions with a small number of parameters and then forecasts the joint distribution of these parameters based on historical data. An approach termed Strategy Search is developed that uses combinatorial optimization methods to search for a bidding strategy that produces the best campaign performance while still meeting specific constraints.

### CROSS REFERENCE TO RELATED APPLICATION

This application claims the benefit of U.S. Provisional Application No. 63/525,795, filed Jul. 10, 2023, entitled “Systems and Methods for Optimal Bidding in Repeated Online First-Price Auctions”, the disclosure of which is incorporated, in its entirety by this reference.

### BACKGROUND

Real-time auctions have emerged over the last decade as a popular method for buying and selling the ability to place online advertisements. This system has gained popularity because it serves the interests of both advertisers and publishers of content that includes an ad. For advertisers, it offers unprecedented control over when, where, and to whom they show their ads. For publishers, it offers the ability to collect the fair market value for each individual impression of an ad that they serve to a viewer.

Within this real-time auction system, advertisers spend their marketing budget by repeatedly bidding into auctions hosted by one or more platforms called Exchanges or Supply-Side Platforms (SSPs). Generally, each auction is for the opportunity to show an individual user an advertisement in a particular placement on a particular webpage. When a user visits a webpage with an available opportunity for placement of an advertisement, a message is sent to the exchange. This initiates an auction that is completed within a few tens of milliseconds. The exchanges operate thousands of auctions every second, and therefore bids must be placed into the auctions by a computer program, i.e., programmatically. This system of purchasing a right to place an advertisement is referred to as Programmatic Advertising.

To enable advertisers to respond quickly to each auction opportunity (where typically, bids must be placed within 50-100 milliseconds), advertisers generally use a Demand-Side Platform (DSP). The DSP provides a technical infrastructure to “listen” for auction bid-requests from SSPs and to respond to those requests with a bid response in a timely fashion (typically, within a few 10s of milliseconds). DSP platforms compete on many features, including the SSPs they are integrated with and the sophistication of the algorithms they let advertisers utilize when placing a bid.

An important consideration for an advertiser when participating in Programmatic Advertising is how much to bid in an auction in response to a bid-request. In recent years, answering this question has become significantly more challenging because SSPs have transitioned from using a second-price auction format to using a first-price auction format.

First-price auctions are more challenging to manage programmatically because bidding optimally requires the bidder to consider how much they expect other participants in the auction will bid. For example, consider an auction with three bidders: bidder A bids $1, bidder B bids $2, bidder C bids $2.50. In a second-price auction, bidder C pays $2.01, but in a first-price auction, bidder C pays $2.50, meaning bidder C would have been better off if they could have “predicted” the second highest bid and accordingly bid lower.

Following the transition to first-price auctions, SSPs and DSPs added tools, called bid-shaders, to aid advertisers in mitigating the risk of overpaying in first-price auctions. Bid shading is a principled approach to mitigate overpaying in first price auctions, but it is typically not an optimal strategy in situations that involve repeated auctions and a balancing of multiple objectives, such as may occur when executing a programmatic advertising campaign.

Embodiments are directed to solving these and other disadvantages of conventional approaches to bidding in a repeated first-price auction, either alone or in combination.

### SUMMARY

The terms “invention,” “the invention,” “this invention,” “the present invention,” “the present disclosure,” or “the disclosure” as used herein are intended to refer broadly to all the subject matter disclosed in this document, the drawings or figures, and to the claims. Statements containing these terms do not limit the subject matter disclosed or the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential or required features of the claimed subject matter, nor is it intended to be used in isolation to determine the scope of the claimed subject matter. The subject matter should be understood by reference to appropriate portions of the entire specification, to any or all figures or drawings, and to each claim.

Embodiments are directed to systems, methods, and apparatuses that implement a bidding strategy that outperforms bid shading in situations that involve repeated bids into first-price auctions. In some embodiments, the novel aspects of the disclosed solution are twofold.

First, an approach termed Inventory Forecasting is disclosed and developed. This approach functions to convert the online real-time repeating auction scenario into a problem that can be optimized offline. In one embodiment, inventory forecasting involves summarizing auctions with a small number of parameters and then forecasting the joint distribution of these parameters based on historical data. Second, an approach termed Strategy Search is disclosed and developed. This approach uses combinatorial optimization methods to search for a bidding strategy that produces the best campaign performance while still meeting specific constraints.

An advantage of the disclosed (and/or described) solution is its capacity to strategically select bid prices to achieve specific objectives across all bids. An example of such an objective is cost per action (CPA). This objective is a measure of performance across all the auctions won. Bid shading solutions are limited in their ability to optimize such an objective since such solutions operate solely at the level of a single bid request.

Based on investigations and simulations performed by the inventors, it has been demonstrated that the proposed pricing system performs better than classic bid shading techniques and is applicable in a scenario involving repeated bidding into first or second price auctions (such as used in programmatic advertising). This ultimately leads to enhanced return on investment (ROI) for a bidder using the proposed approach.

In some embodiments, the disclosed and/described approach may be implemented by the following set of steps, stages, functions, processes, or operations:
Access or Develop a Win-Rate Model Based on Historical Auction Data. In one embodiment, the model expresses a probability of winning an auction as a function of bid price. As an example, the model may output k and A, the parameters of Weibull distribution, such that the predicted probability of winning an auction is the cumulative probability of the Weibull distribution at the bid price;
   This Weibull distribution is appropriate as a parameterized distribution over positive real values (e.g. dollars above the auction bid floor) where k is the shape parameter and λ is the scale parameter, but other distributions may be used, such as the log-normal distribution or histogram fit;
Access or Develop a KPI Model Based on Historical Auction Data. In one embodiment, the model expresses the value (or impact) of winning an auction for a specific KPI. As an example, the model may output p_{conv}, such that this value represents the probability that showing an advertisement in the auctioned placement will receive credit for a subsequent action, such as a user making an online purchase or performing another desired action;
   In addition to historical auction data, this type of model may also incorporate data related to the value of an auction to the bidder. In advertising, this data might be data such as which user took an online action, at what time they took the action (and hence how soon after viewing an ad the user performed the action), and what absolute or relative value/cost the action had;
Generate an Inventory Forecast as a Prediction of a Joint Histogram over the Output of the Win-Rate and KPI Models (i.e., over k, λ, and p_{conv}) for all auctions that are or will be available to bid upon;
   This typically requires knowledge of the available auctions of interest, and is addressed by the disclosed Search function;
Use the Inventory Forecast to Execute a Search to Identify a Bidding Strategy to Optimize a specified KPI. A Bidding Strategy consists of: (1) a Bid Price Function that Determines the Bid Price of An Auction Based on the Outputs of the Win-Rate and KPI Models and which is used to Compute the Worth-To-Volume Ratio of the Auction; and (2) a Worth-To-Volume Ratio Threshold that is used to determine whether to Submit a Bid or Abstain from Bidding;
   In some embodiments, the search includes an outer process that parametrically searches over possible bid price functions, and an inner process that evaluates the performance of each bid price function using the Inventory Forecast;
   In some embodiments, the resulting bidding strategy and/or model(s) performance may be evaluated to decide if retraining or adjustment of the search process or of one or more of the models is desirable;
Deploy a Determined Bidding Strategy. Apply the Bid Price Function and use the Worth-to-Volume Ratio Threshold to Decide Whether to Submit a Bid or Not Bid;
   Each programmatic auction is evaluated in near real-time based on the selected strategy to determine whether to bid and at what price. This decision is either submitted to the exchange (SSP) directly or to the advertiser via an intermediary ad-tech partner;
   In some embodiments, the resulting bidding strategy and/or model(s) performance may be monitored/evaluated to decide if retraining or adjustment of the search process or of one or more of the models is desirable.

Other objects and advantages of the systems, apparatuses, and methods disclosed will be apparent to one of ordinary skill in the art upon review of the detailed description and the included figures. Throughout the drawings, identical reference characters and descriptions indicate similar, but not necessarily identical, elements. While the embodiments disclosed or described herein are susceptible to various modifications and alternative forms, specific embodiments are shown by way of example in the drawings and are described in detail herein. However, embodiments of the disclosure are not limited to the exemplary or specific forms described. Rather, the disclosure covers all modifications, equivalents, and alternatives falling within the scope of the appended claims.

### BRIEF DESCRIPTION OF THE DRAWINGS

Embodiments of the disclosure are described with reference to the drawings, in which:

FIG. 1 is a flow chart or flow diagram illustrating a process, operation, method, or set of functions for implementing an optimal bidding strategy in situations that involve repeated bids into first-price auctions, in accordance with some embodiments;

FIG. 2 is a diagram illustrating elements or components that may be present in a computing device, server, or system configured to implement a method, process, function, or operation in accordance with some embodiments; and

FIGS. 3, 4, and 5 are diagrams illustrating an architecture for a multi-tenant or SaaS platform that may be used in implementing an embodiment of the systems, apparatuses, and methods disclosed and/or described herein.

### DETAILED DESCRIPTION

One or more embodiments of the disclosed subject matter are described herein with specificity to meet statutory requirements, but this description does not limit the scope of the claims. The claimed subject matter may be embodied in other ways, may include different elements or steps, and may be used in conjunction with other existing or later developed technologies. The description should not be interpreted as implying any required order or arrangement among or between various steps or elements except when the order of individual steps or arrangement of elements is explicitly noted as being required.

Embodiments of the disclosed subject matter are described more fully herein with reference to the accompanying drawings, which show by way of illustration, example embodiments by which the disclosed systems, apparatuses, and methods may be practiced. However, the disclosure may be embodied in different forms and should not be construed as limited to the embodiments set forth herein; rather, these embodiments are provided so that the disclosure will satisfy the statutory requirements and convey the scope of the disclosure to those skilled in the art.

Among other forms, the subject matter of the disclosure may be embodied in whole or in part as a system, as one or more methods, or as one or more devices. Embodiments may take the form of a hardware implemented embodiment, a software implemented embodiment, or an embodiment combining software and hardware aspects. For example, in some embodiments, one or more of the operations, functions, processes, or methods disclosed and/or described herein may be implemented by a suitable processing element or elements (such as a processor, microprocessor, CPU, GPU, TPU, QPU, state machine, or controller, as non-limiting examples) that are part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory computer-readable data storage elements. In some embodiments, the set of instructions may be conveyed to a user over a network (e.g., the Internet) through a transfer of instructions or an application that executes a set of instructions.

In some embodiments, the systems and methods disclosed herein may provide services or functionality through a SaaS or multi-tenant platform. The platform provides access to multiple entities, each with a separate account and associated data storage. Each account may correspond to an individual, a client, a group of clients, an advertiser, a demand side platform, an industry, or an organization, for example. Each account may access one or more services, a set of which are instantiated in their account, and which implement one or more of the methods or functions disclosed and/or described herein.

In some embodiments, one or more of the operations, functions, processes, or methods described herein may be implemented by a specialized form of hardware, such as a programmable gate array, application specific integrated circuit (ASIC), or the like. Note that an embodiment of the disclosed and/or described methods may be implemented in the form of an application, a sub-routine that is part of a larger application, a “plug-in”, an extension to the functionality of a data processing system or platform, or other suitable form. The following detailed description is, therefore, not to be taken in a limiting sense.

### Advertising Campaigns: Budgets and Tactics

Advertisers, often in concert with a Media Advertising Agency, typically organize their advertising efforts into what are termed campaigns. A campaign typically has a specified set of content (sometimes referred to as creatives). These are images or videos that will be displayed as advertisements, for a specified duration (e.g., the month of January), and within an overall budget (e.g., $50,000).

A campaign may be split into a set of tactics. Each tactic represents a strategy for spending advertising dollars effectively. For example, a tactic might target a particular demographic or group of people that the advertiser believes will respond to the selected creatives (content) and the accompanying message. Each tactic will typically have one or more key performance indicators (KPIs) associated with it that are used to measure the success of the advertising tactic or the overall campaign. For example, a tactic might have a target cost per attributed action of $40 as a KPI.

Tactics may have other relevant KPIs besides or in addition to target cost per attributed action (e.g., video completion rate or cost per user site visit, as non-limiting examples) and different constraints. For example, instead of having a fixed budget a campaign or tactic might have a fixed number of impressions. In such situations, the disclosed and/or described system and methods can be adapted for such scenarios.

As an example of a tactic, a company might desire that a specific budget be spent on ads, over a specified period, with a cost per ad between a minimum and maximum range, and a desired number of viewer actions in response to the ads.

In programmatic advertising, a tactic may be associated with a set of filters and/or rules that define which bid requests to bid on and how much to bid. A tactic's filters and/or rules can be more-or-less sophisticated and may rely in some cases on a machine learning model, but for the purposes of this disclosure, an important attribute is that these filters and rules do not utilize information about what other future auctions will be available to bid on, nor how much other advertisers are likely to bid for a given piece of inventory or add placement opportunity. That is, conventional approaches do not consider the repeated bidding aspect of the situation or the first price auction dynamics and its impact on an optimal strategy.

To mitigate the risk of overpaying in first-price auctions, conventional tactics generally rely on bid-shading techniques. After a bid is selected by a tactic, and just before it is submitted to an auction, it is passed to a bid-shader (which is generally part of the DSP's or SSP's technology stack). The bid shader is the first point in the conventional bidding process at which the first-price auction dynamics (e.g., information about what other advertisers may bid for a piece of inventory or opportunity) are considered.

In some embodiments, the disclosure is directed to systems, apparatuses, and methods for determining an optimal bidding strategy for use in a scenario involving a repeated first price auction. In some embodiments, an approach is disclosed and/or described that uses information regarding first-price auction dynamics earlier in the decisioning process of a tactic. As will be described further, by doing so an improved impact on a specific KPI can be achieved. As a general statement, embodiments determine an optimal bidding strategy by determining (a) the likelihood of a specific bid having a positive impact on a desired KPI, and (b) given that bid amount, what is the expected win-rate for the bid?

### Bid Shading

DSPs and SSPs offer bid shaders as a tool in their platforms to assist advertisers in avoiding overpaying in first price auctions. A bid shader lowers (i.e., shades) the advertisers bid price right before it is submitted to an auction in hopes of reducing the amount the bidder will pay, but with the trade-off that doing so may reduce the probability that the bidder will win the auction. There are many possible algorithms for bid shading (many of them related to an approach termed surplus optimization¹), but a key defining attribute of all shaders (as opposed to the disclosed approach) is that they only lower bids—they never choose not to bid in an auction. ¹ See https://arxiv.org/pdf/2107.06650.pdf.

This behavior is because bid-shading is not part of the strategy/tactic itself, rather it is service offered by the DSP/SSP to save the advertiser money. As an example, if the advertiser bids $1, the shader won't suggest not bidding. Instead, the bid shader will suggest that it can reduce the bid to $0.90 without drastically effecting the win-probability and will do that and then take X % of the savings as a fee for the bid shading service.

Another key property of conventional bid shaders is that they rely on the “pre-shaded” price accurately reflecting the value of an auction to the advertiser. This is problematic for two reasons. First, in a repeated auction scenario such as used in programmatic advertising, the value of an auction inevitably depends on the quality and quantity of the other auctions available to the advertiser. Second, it is not always possible to reflect the value of an auction for all the objectives of a campaign and with associated risk-tolerances in a single number.

Fundamentally, conventional bid shaders make a tradeoff between bid-price and win-probability. Often, DSPs and SSPs describe their bid shaders as being conservative in making this tradeoff—that is, they attempt to reduce bid prices without significantly impacting the win-rate. Though little information is provided regarding the exact bid shading algorithm being used, it is apparent that conventional bid shaders don't offer advertisers an ability to “tune” this trade-off based on the needs/objectives of their tactic(s) or campaign.

Irrespective of the specific bid shader algorithm applied, bid shaders generally rely on predictions regarding how the bid-price will affect the auction win probability. These predictions are typically derived from large amounts of historical auction outcome data which are used to train a machine learning (ML) model which makes the predictions. Fundamentally, these models, referred to herein as win-rate models, capture information about how much others are likely to bid for an auction. In some embodiments, the disclosed and/or described approach may also incorporate a win-rate model.

One reason for the ability of the disclosed and/or described approach to outperform conventional bid shading methods is that the approach brings the win-rate model, and its consideration or understanding of first-price auction dynamics, forward to an earlier point in the decision-making process such that unlike bid-shading, it can be used decide whether to bid or abstain from placing a bid. Furthermore, the inventory forecast allows this decision-making process to reason over all the bids the tactic will make over a period of time and thus be more holistic—specifically, a combinatorial optimization approach can be applied. Together these advantages mean that the disclosed and/or described approach can yield significantly better key performance metrics than tactics that rely on conventional bid shaders.

However, involving a win-rate model earlier in the decision-making process is complicated for several reasons. For example, on a given day, there may be as many as tens of billions of auctions, and optimizing which small set of those to place a bid for to optimize a KPI is a challenging combinatorial optimization problem. In addition, the set of possible bid prices for each auction is essentially continuous, meaning there is (in theory) an infinite set of possible bid prices to consider in a solution to the optimization problem. Finally, the auctions take place in real-time meaning the approach should be applicable to online decisioning with stringent latency requirements. Embodiments address these challenges and provide an efficient and effective solution for determining a bidding strategy under these conditions.

### Win-Rate Model and KPI Model

To overcome the disadvantages associated with conventional approaches to implementing a bidding strategy and the use of bid shaders, an embodiment may incorporate two types of models that are used in the Ad-Tech industry. However, as disclosed and/or described herein, embodiments use these models in a very different manner from conventional approaches (i.e., embodiments use the models in combination with an inventory forecast of the type disclosed and/or described to search for and identify optimal bidding strategies):
A win-rate model, trained on historical auction outcome data, that outputs parameters of a function that describes the win-probability of the auction as a function of bid-price. Without a loss of generality, assume the model outputs two parameters: k and lambda (λ). The model takes as an input information about an auction, for example information about how large an advertisement space is that is being auctioned (e.g., where the space is located on a webpage), information about the type of user that is expected to view the ad, and/or what website it is on, as non-limiting examples. It is important that the model be kept up to date using current auction data (where this can involve online-methods and/or model retraining, as examples);
   In one embodiment, the win-rate model is based on a survival model approach² in which the model outputs the parameters of a probability distribution (or a mixture of probability distributions). In one embodiment, the model outputs the parameters of a single Weibull distribution (not a mixture) which has two parameters, k and lambda (λ). The cumulative density function of this distribution represents the probably of winning an auction as a function of bid-price, i.e., it is a form of win-rate model; ² See https://arxiv.org/abs/1806.08324.
      The model is trained using the negative log likelihood of the auction outcome as the loss function. In this way, the model outputs parameters that maximize the likelihood of observing the historical auction data in the training set. Once trained, the model can then be used to transform the information included in a bid request into a predicted win probability as a parameterized function of bid price (e.g. a bid of $0.10 has a 3%-win probability and a $0.20 bid has a 5%-win probability, etc.);
A KPI model that takes the same information as the win-rate model as input, but outputs information about the extent to which winning an auction will drive (i.e., improve or satisfy) a specific KPI or set of KPIs. For example, and without loss of generality, the model might output the probability an ad will receive credit for a last-touch conversion if the auction is won (i.e., a KPI in the form of p_{conv}). In general, the KPI model represents the resulting value for a KPI as a function of winning an auction;
   A common KPI used to evaluate an advertising campaign is Cost Per Last-touch Attributed Order. In this case, an advertisement that is the last ad showed to a user before they buy a product on a website receives credit for generating the purchase. An advertiser might have a target cost of $40 per last-touch attributed order. In this example, the KPI model along with a calibration process are trained to output the probability of a particular auction generating a last-touch attributed order. If this model outputs 0.0005 (as an example), then the auction could be considered to have a value of $0.02 (i.e., probability x target cost) according to the model;
      The KPI model may be trained on historic ad impression data and labeled with attribution data. Once trained, an inference process using the model can be used to transform information included in a bid request into a prediction about the ability of the bid request to drive a client's KPI or KPIs;
   In general, a bidder may have multiple objectives, in which case the KPI model may produce multiple outputs describing the impact winning an auction would have on each KPI (where non-limiting examples of other KPIs may include Cost Per Click, Cost per Site Visit, or Cost Per Video Completion).

### Inventory Forecasting

Another aspect of an embodiment of the disclosed and/or described approach is to convert a real-time bidding problem into an offline problem that can be optimized holistically. To accomplish this, the approach introduces a stage or process termed “Inventory Forecasting”. In Programmatic Advertising, each auction sells a piece of advertising inventory (an opportunity to present an ad), so the auctions themselves are sometimes referred to as inventory.

In some embodiments, an Inventory Forecast is a prediction about a set of auctions that are expected to be available to a tactic over the duration of a campaign, or over a portion of the duration of a campaign. In some embodiments of the disclosed and/or described approach, an item of inventory can be represented or summarized for the purposes of optimizing a bidding strategy by the outputs of the win-rate model and the KPI model.

The win-rate model captures the information about how much competitors are likely to bid in an auction, while the KPI model captures the value of the auction for achieving or improving one or more KPIs. Therefore, a prediction about what auctions will be available to a tactic can be mathematically represented as a prediction of the joint histogram over the outputs of those two models, which, in the examples, and without loss of generality, is the joint histogram over k, lambda (Δ), and p_{conv}.

In some embodiments, the disclosed and/or described process generates an inventory forecast by sampling from a set of auctions that occurred previously. Information about prior auctions is logged, including information about what filters each bid request meets and the features of each bid request that are used to run an inference process with the win-rate and KPI models. In this regard, a Demand-Side Platform (DSP) may receive a feed of all bid requests that are available to bid upon. This set of bid requests provides a large sample that can be used for training a model or models.

For example, if someone were attempting to design a bidding strategy for a tactic over a 1-week period, a sample of auctions would be taken from historical log files for both the prior week, and the week before that. If the number of auctions that is allowed to be won per user is limited—a constraint termed frequency capping—then the sample should be the set of all auctions that a sample of users produced. Auctions typically include one or more anonymous user identifiers (such as cookies or device ids) as information about the auctions. After the sample of auctions is taken, the set would be filtered according to the requirements/criteria associated with the tactic, e.g., only auctions on a particular device type and/or only auctions for a creative size (i.e., an ad space) of 300×250.

The win-rate and KPI models would be applied to this sample of data to a generate table, referred to as the inventory forecast, in which each row represents an auction and contains (as an example) the timestamp of the auction, the user identifier associated with the auction, the outputs of the win-rate model (which describe the auction's first-price dynamics), and the outputs of the KPI model (which describe the value of the auction to a bidder).

The joint distribution over the win-rate model outputs and KPI model outputs (e.g., k, lambda (λ), and p_{conv}) during the prior week would then be compared to the joint distribution over the week before that by measuring the mutual information. The process of sampling auctions would be repeated with increasing sample sizes and the sample size at which the mutual information plateaus at a maximum value is selected. The inventory forecast for the coming week is then taken to be the joint histogram over the prior week using the final selected sample size.

Approaches that involve using multivariate time-series forecasting methods to incorporate additional historical auction data to capture one or more of daily, weekly, monthly, and annual trends in the joint histogram may also be used. In these embodiments, a current time-series forecasting model (e.g., an LSTM or AutoBNN) is trained on the model outputs for months or years of historical auction data (e.g., k, lambda (λ), and p_{conv}). Inference with the model is then used to generate the multivariate time-series of the model outputs over the duration of the inventory forecast (e.g., 1 week). Each element of the generated time-series is then taken as a row in the inventory forecast.

### Strategy Search

Another aspect of an embodiment is to leverage the inventory forecast to search for a bidding strategy that will optimize the KPIs of a tactic. In one embodiment, the bidding strategy consists of: (1) a bid price function that determines the bid price of an auction based on the outputs of the win-rate and KPI models and which is used to compute a score for each auction (the worth-to-volume ratio); and (2) a score threshold value (the worth-to-volume ratio threshold) that is used to determine whether to submit a bid for an auction, or abstain and not submit a bid. In some embodiments, the search may be subject to a constraint that the selected bidding strategy satisfies applicable hard constraints (for example that the strategy spends the budget accurately and complies with constraints on the frequency with which users/viewers see advertisements).

In one embodiment, the strategy search consists of two processes (although use of a single process is also possible); an outer process that searches over possible bid price functions, and an inner process that applies combinatorial optimization to evaluate the performance of the bid price functions using the inventory forecast. The outer process keeps track of which bid price function generates the “best” estimated performance while satisfying the applicable constraint(s).

### Strategy Search—The Outer Process

The set of possible bid prices on the inventory forecast (which typically consists of tens of millions of rows) represents an enormous search space even if bid prices are quantized. Therefore, to make exploring the space of possible bids feasible, the outer process searches within a parameterized family of functions, denoted as F. The family of functions maps the win-rate and KPI model outputs for an auction/bid-request (e.g., k, lambda (λ), and p_{conv} in some embodiments) to a bid price. As non-limiting examples, the family (F) or a function in the family can take the form of:

$$\\ bid price = F ( k , λ , {p}_{conv} \vert theta ( θ ) ) , or$$

$$\\ bid price = surplus\_maximizing \_bid {\_price}^{3} + F ( k , λ , {p}_{conv} \vert theta ( θ ) ) .$$

The outer process searches over possible values of theta to find the bidding strategy that achieves the “best” outcome, as assessed by the inner process, while still meeting the constraints/requirements of a campaign. ³ See https://arxiv.org/pdf/2107.06650.pdf.

In some embodiments, and as a non-limiting example, an approach is to search over possible values of the theta parameters using a black box optimization method (e.g., a Genetic Algorithm or Bayesian Optimization). For each theta, the inner process evaluates the performance of the resulting bidding strategy and returns this information to the outer process. The outer process using this information to decide what value of theta to test next. Ultimately, the theta that yields the best predicted outcome (e.g., the lowest expected cost per last-touch attributed action) while meeting the constraints of the campaign (e.g. the distribution of the predicted cost of the auctions won aligns with the budget of the tactic) is selected as a “final” bidding strategy.

In one embodiment, the family of functions (F) can take the form of a multi-layer perceptron (MLP) that makes use of Fourier Features⁴, in which case theta (θ) represents the weights of the network. In another embodiment, the family can be in the form of a multivariate polynomial, in which case theta (θ) represents the coefficients of the polynomial. ⁴ See https://bmild.github.io/fourfeat/.

In some embodiments, a function in the family of functions can operate to round or modify the resulting bid prices to be one of a discrete set of values, in which case theta (θ) could include the set of discrete values that are allowed.

In the case that a strategy includes multiple KPIs, theta (θ) can include parameters that are used by the inner process to weight the relative importance of the different KPIs, such that the impact of different weighting can be assessed.

The selection of which family of functions (F) the outer process explores is preferably based empirically on which family and/or functions consistently finds the most performant bidding strategies given the inventory forecast method, KPI model, and the win-rate model being used. However, the selected family of functions (F) preferably does not have too many free parameters, theta (θ), as that may increase the computational requirements of the outer process to a level that is impractical.

### Strategy Search—The Inner Process

The inner process evaluates the predicted performance of a given bidding strategy, specified by theta (θ), being explored by the outer process, which as described, specifies the bid price for an auction (the bid price function) and optionally the relative weighting of different KPIs. This evaluation is made possible by the Inventory Forecast. The Inventory Forecast allows a real-time bidding problem to be framed as a combinatorial optimization problem: i.e., given a set of auctions (the inventory forecast) what subset (or combination) of auctions should be selected to optimize the outcome. In particular, this combinatorial optimization problem is closely related to the classic knapsack problem⁵, but unique in that the packages (auctions) being placed into the knapsack will only count if the auction is won (not lost). ⁵ https://en.wikipedia.org/wiki/Knapsack problem.

In one embodiment, this knapsack problem is solved by modifying the greedy approximation heuristic⁶ to account for this unique situation. A valuable aspect of this heuristic is that after being applied to the inventory forecast, it can subsequently be used in low-latency near-real-time environments. ⁶ Dantzig, George B. (1957). “Discrete-Variable Extremum Problems”. Operations Research. 5 (2): 266-288. doi:10.1287/opre.5.2.266.

To apply the greedy approximation heuristic, one value must be selected to represent the volume of each auction if it is placed into the “knapsack”; another value must be selected to represent the worth of each auction if it is placed into the “knapsack”; and a third value must be selected to represent the volume of the “knapsack”.

Given these three values, the heuristic aims to maximize the worth (value) placed into the “knapsack” by sorting the auctions by their worth-to-volume ratio, and then putting the auctions with the highest ratio into the knapsack first. Note that the values or parameters that are taken as the “volume” of an auction, the “worth” of an auction, and the “volume” of the knapsack can be selected to accommodate the business objectives and constraints of a particular tactic—as is typical of a combinatorial optimization problem. In general, the “worth” of each auction is defined to represent what the tactic/campaign aims to maximize, while the “volume” of the knapsack and the auctions are defined to represent the constraints.

For example, for a campaign intended to minimize cost per last touch attributed action while spending a specific budget amount, the bid price could be selected to represent the volume of an auction; p_{conv} could be selected to represent the worth of an auction; and the volume of the knapsack could be selected to represent the total dollar budget of a campaign (which may be scaled down according to the duration of the inventory forecast relative to the campaign and the down sampling rate of the inventory forecast).

In another scenario, a campaign may be constrained in the number of impressions it is allowed to win, in which case the volume of an auction would always be one. In a scenario like this, the tactic may have two KPIs that must be balanced: minimize both the cost-per-conversion and the cost-per-impression. In this case, the worth could be a weighted and scaled combination of p_{conv} and bid-price, where theta (θ) defines the weighting and scaling. The weighting would then then be optimized by the disclosed outer process to achieve a desirable trade-off between the KPIs.

After the auction worth, auction volume, and knapsack volume are defined to accommodate the business problem, a modified version of the greedy approximation heuristic can be used to select on auctions to bid to achieve the best outcome (maximize the worth). For each auction in the Inventory Forecast: first, the bid price function is used to compute the bid price of the auction based on its model outputs (e.g. k, lambda, p_{conv}); then, the win probability at that bid price is calculated using the win-rate model outputs; next, the worth, the volume, and the worth-to-volume ratio are calculated; and finally, the auctions in the forecast are sorted by their worth-to-volume ratio in descending order.

The greedy heuristic would then normally select the optimal set of auctions to bid upon by “placing” them in the knapsack one at a time, in order from highest to lowest worth-to-volume ratio, until the knapsack was full. However, because auctions are won and lost stochastically, the heuristic must be modified to use a simulation.

This modification involves simulating whether each auction is won or lost, in order from highest to lowest worth-to-volume ratio. Each auction outcome is simulated as a biased coin according to the auction's win probability using a random number generator. As the simulation proceeds through each auction, cumulative metrics are stored with each row of the inventory forecast, including: the total-number-of-auctions-won thus far, the total-cost-of-auctions-won (i.e., total-bid-price-of-auctions-won), the total-volume-of-auctions-won, the total-worth-of-auctions-won, and optionally other cumulative metrics related to individual KPI model outputs (which may also be stochastically simulated).

This simulation is then repeated in a Monte-Carlo fashion, and the associated cumulative metrics are stored for each simulation. The number of simulation based on compute and/or time constraints, but 500 is a reasonable number. Note, that if a tactic includes a frequency-cap constraint, then it can be applied in the simulation process by preventing auctions wins that violate the constraint.

Once the simulations are complete, the cumulative metrics can be used to select a worth-to-volume ratio threshold that will determine which auctions to bid upon and which to ignore—thus completing the combinatorial optimization process. Specifically, only auctions with a worth-to-volume ratio above the worth-to-volume ratio threshold will be bid upon. The worth-to-volume ratio threshold is such that cumulative metrics from the simulations meet the business constraints of the campaign as best as possible.

For example, if business constraints require the budget to be spent with a 95% confidence level, then the threshold would be selected such that the cumulative total-volume-of-auctions-won metric (e.g., the cost) at the last auction above that threshold was greater than the knapsack volume (e.g., the budget) in 95% of the simulations. Note, it is possible that the bid price function is such that even bidding on all the auctions does not meet the criteria, in which case this information is returned to the bidding process and the theta values would be deemed unusable by the outer process.

Once the worth-to-volume ratio threshold is determined (or otherwise selected), the threshold and the predicted performance of the theta parameters can be returned to the outer process. The inner process will return the cumulative metrics across the simulations at the threshold selected.

The outer process can then consider the distributions of these metrics to determine which strategy performs best from a business perspective. For example, if p_{conv} is taken as the worth, then the total-worth-of-auctions-won metric will represent the expected number of last touch attributed actions in each simulation. The outer process would then use this and the cost of each simulation to compute the median cost-per-last-touch attributed action across the simulations, such that the theta that represents the best bidding strategy could be selected.

If the strategy search is instead implemented as a single process, in one embodiment the disclosed approach may function or operate as follows:
A model is created that takes k, lambda λ, and p_{conv} (or other KPI or KPIs) as inputs, and outputs a bid price (which potentially is zero, indicating a no-bid). The model is trained by gradient descent to optimize the sum of multiple terms. The first term incentivizes the model to maximize the KPI(s). For some of the example models discussed, this term is p_{conv} multiplied by the win-rate predicted given the bid price generated by the models. The other terms are used to regularize the expression and serve to ensure that the bid strategy observes any hard constraints;
   For example, to ensure the budget is not over or under spent, a regularizing term representing the spend is added—for example, the win-rate based on the outputted bid price multiplied by the bid price. Each regularizing term may be multiplied by a weight;
   To arrive at a strategy, the model may be trained by gradient descent. If a constraint is not met, the weight associated with the constraint is increased and the model is retrained. The process of adjusting the weight of regularizing terms is repeated until the model converges to a bidding strategy that meets the constraints of the campaign.

### Real-Time Deployment of Strategy

Once a bidding strategy is determined or selected, it can be deployed to place bids into online auctions and do so substantially in real time. In the case of programmatic advertising, when an auction arrives at a DSP, the bid-request's values (URL, user information, and IP address, as non-limiting examples) may be used to look up the features needed for model inference in a real-time feature store.⁷ ⁷ For a description of the Implementation, operation, and use of such a feature store, see U.S. patent application Ser. No. 17/839,252, filed Jun. 13, 2022 (corresponding to U.S. Patent Application Publication No. US 2022/0398433), titled “Efficient Cross-Platform Serving of Deep Neural Networks for Low Latency Applications”, assigned to the assignee of the present disclosure, and the contents of which is hereby incorporated by reference.

As a non-limiting example, an auction might include a User Id: 103019390129923i, an IP address: 10.0.0.127, a URL: https://www.businessinsider.com/ai-is-set-to-dominate-cannes-lions-ad-festival-2024-6, a Device Brand: Apple, and a Creative size 300×250. From the URL and User Id other numeric features may be determined or found.

An inference process with the win-rate and KPI models is executed on the retrieved features to yield a set of parameters (e.g., k, λ, and p_{conv}) that describe an auction (note that the KPI (here p_{conv}) may be different for a different strategy or goal). The bid-price is calculated as F(k, λ, p_{conv}|theta θ), and the worth-to-volume ratio is calculated (e.g., p_{conv}/bid-price for this example embodiment using the knapsack heuristic). If this ratio is above the worth-to-volume ratio threshold selected by the strategy search process, then the process places a bid at the calculated bid price; otherwise, the process abstains from bidding.

In some embodiments, rather than being deployed as a system that bids directly into auctions, the selected bidding strategy may be deployed as a feature of a system that shares information regarding which auctions to bid on, and how much to bid. This may be done via integrations with a SSP, DSP, or other Ad-Tech partner of a client (such as an advertiser).

As an example, some SSPs allow partners to generate Private Marketplaces (PMPs) in which subsets of auctions are tagged with DealIDs that are made available to advertisers for use in the DSP of their choice. In such situations, a bidding strategy can be deployed by labeling the auctions that the strategy determines should be bid upon into different DealIDs according to a bid price the strategy selects.

After a bidding strategy is deployed, it may be monitored and adjusted to ensure a desired level of performance. The bidding strategy, together with the inventory forecast, provides an expectation regarding the number of eligible bid-requests, bids, and auction wins at each timepoint within the duration of the strategy, along with an expectation regarding the value of the wins (e.g., the distribution of p_{conv} or other KPI for the wins). These expectations may be used to monitor whether the strategy is performing as intended.

If the number of bids and/or wins are consistently slightly below expectation, then the worth-to-volume ratio threshold for bidding can be adjusted down slightly (or vice versa). If this adjustment does not resolve the issue and the deployed strategy's bids and/or wins continue to differ significantly enough from expectations, then the underlying models and inventory forecast should be updated (e.g., by retraining a model or models), and the strategy redesigned.

### Validation of Approach

### Datasets

To validate the disclosed and/or described approach for optimizing a bidding strategy and demonstrate that it delivers a more desirable impact on one or more KPIs than use of a conventional bid-shading approach, one can assume the win-rate model and KPI model are accurate, and then simulate the performance of different bidding strategies on a sample of auction data. The inventors utilized this validation process on two distinct datasets and evaluated the performance of three different bidding strategies when applied to the datasets:
Bid Shading via Surplus Optimization. This strategy represents a traditional or conventional bidding approach based on bid shading. The strategy bids on the auctions with the highest value to the advertiser first (i.e., the highest p_{conv} or relevant KPI), and only bids on as much inventory as necessary to spend the budget. The conventional strategy does not consider the win-rate model when deciding which of the available inventory to bid on, but it does use the win-rate model to shade the bid prices before bids are placed based on surplus maximization.⁸ In this example, the pre-shaded price of the inventory, which is the bid-price before shading, is taken to be p_{conv} multiplied by the target CPA (cost per attributed event) of the campaign; ⁸ As described in https://arxiv.org/pdf/2107.06650.pdf.
Combinatorial Optimization Applied to Bid Shading via Surplus Optimization. This strategy brings the win-rate model forward in the decision-making process. The bid prices are still determined using the surplus maximization methodology (rather than a strategy search of the form disclosed and/or described herein), but the inventory to bid on is selected using a greedy knapsack heuristic together with the win-rate model and the inventory forecast;
   This strategy utilizes a variation of the combinatorial optimization aspect disclosed and/or described herein, but not the strategy search aspect. In that sense, it is a variation of the disclosed and/or described approach that differs from and improves upon the conventional approach but does not incorporate all of the features and techniques disclosed and/or described herein;
Strategy Search based on Combinatorial Optimization. This strategy is based on the approach disclosed and/or described herein. The win-rate model and inventory forecast are used to search for a set of auctions and bid prices that maximize the desired KPI(s);
   This embodiment incorporates both the inventory forecast to enable combinatorial optimization and the implementation of a strategy search process.

### Dataset 1

A first dataset was an inventory forecast for a tactic with a duration of 27 campaign days and a campaign budget of $35,000. The KPI used was last-touch cost-per-attribution (CPA). The win-rate model and KPI were both trained and calibrated on approximately 3-months of data. The inventory forecast contained 4,281,770 rows (auctions) and represented 0.15% of inventory over a 1-week time period, resulting in a budget of $13.61 given the duration and sampling rate of the forecast ($35,000*7 days/27 days*0.15%).

### Dataset 2

A second dataset was an inventory forecast for a tactic with a duration of 30 campaign days and a budget of $44000. The KPI used was last-touch CPA. The win-rate model and KPI were both trained and calibrated on approximately 2-months of data. The inventory forecast contained 7,190,005 rows and represented 0.15% of inventory over a 1-week time period, resulting in a budget of $15.40 given the duration and sampling rate of the forecast.

The three bidding strategies described were applied to each dataset. The expected number of impressions and conversions were determined based on the selected bid prices and the win-rate and KPI model outputs.

The results of the evaluation/validation (illustrated in Table 1), indicate that the Strategy Search based on Combinatorial Optimization is most effective at driving (positively impacting) the KPI compared to the other approaches. As illustrated in Table 1, the Strategy Search based on Combinatorial Optimization (i.e., the disclosed and/or described approach) outperformed the other two methods in both datasets, achieving the lowest CPA values of $8.781 for Dataset 1 and $15.895 for Dataset 2. This consistent performance across different datasets further validates the effectiveness of the disclosed and/or described Strategy Search based on Combinatorial Optimization in reducing CPA when compared to the conventional approach using bid-shading (as well as the alternate approach that did not use the disclosed strategy search).

TABLE 1
Comparison of CPA for different strategies
in Dataset 1 and Dataset 2

| | | | Dataset 1 | Dataset 2 |
|---|---|---|---|---|
| | Dataset 1 - | Dataset 2 - | improvement | improvement |
| Strategy | CPA ($) | CPA ($) | (%) | (%) |
| Bid Shading | 17.513 | 18.012 | — | — |
| Bid Shading | 13.927 | 16.935 | 20.476 | 5.979 |
| with Combinatorial | | | | |
| Optimization | | | | |
| Strategy Search | 8.781 | 15.895 | 36.949 | 6.141 |
| with Combinatorial | | | | |
| Optimization | | | | |

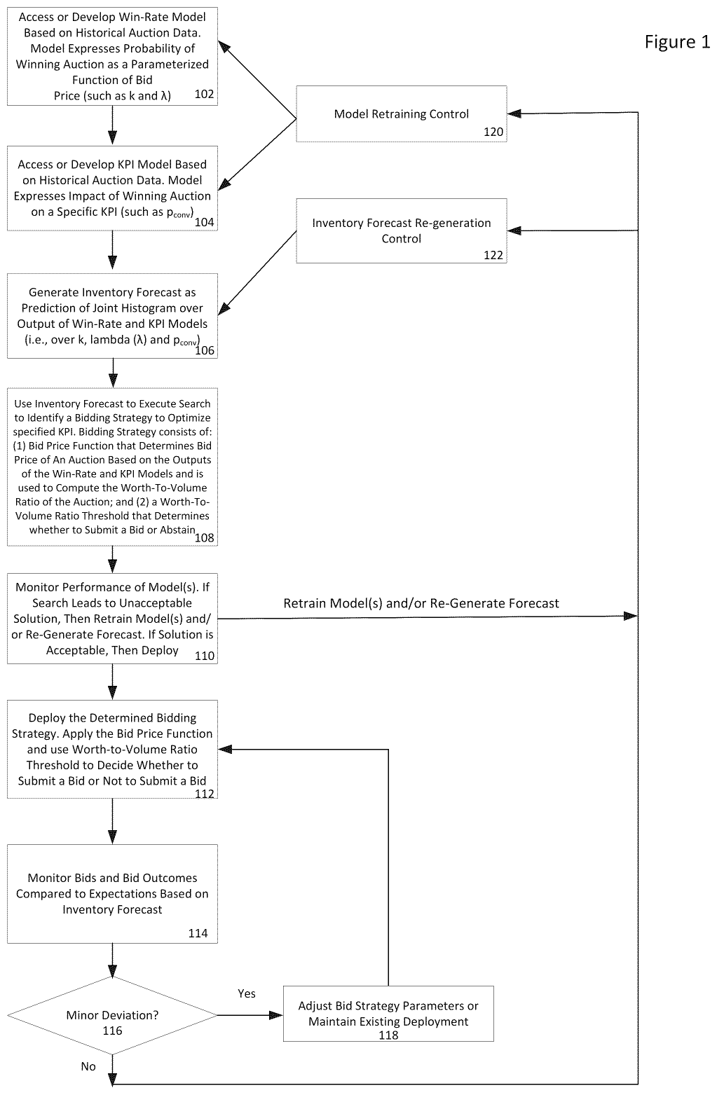

FIG. 1 is a flow chart or flow diagram illustrating a process, operation, method, or set of functions for implementing an optimal bidding strategy in situations that involve repeated bids into first-price auctions, in accordance with some embodiments. These processes or operations may include one or more of the following, as disclosed and/or described herein:
Access or Develop a Win-Rate Model Based on Historical Auction Data. In one embodiment, the model expresses a probability of winning an auction as a function of the bid-price as a Weibull distribution parameterized by k and lambda (λ) (as suggested by step or stage 102);
Access or Develop a KPI Model Based on Historical Auction Data. In one embodiment, the model expresses the impact of winning an action on a specific KPI (e.g., p_{conv} or other KPI) (as suggested by step or stage 104);
Generate an Inventory Forecast as a Prediction of a Joint Histogram over Outputs of the Win-Rate and KPI Models (i.e., over k, lambda (λ), and p_{conv}) (as suggested by step or stage 106);
Use the Inventory Forecast to Execute a Search to Identify a Bidding Strategy to Optimize a specified KPI. A Bidding Strategy consists of: (1) a Bid Price Function that Determines the Bid Price of An Auction Based on the Outputs of the Win-Rate and KPI Models and which is used to Compute the Worth-To-Volume Ratio of the Auction; and (2) a Worth-To-Volume Ratio Threshold that determine whether to Submit a Bid or Abstain (as suggested by step or stage 108);
   In some embodiments, the search includes an outer process that searches over possible bid price functions, and an inner process that evaluates the performance of each bid price function using the inventory forecast;
Monitor Performance of the Model(s). If the Search Leads to an Unacceptable Solution, Then Retrain one or more of the Models. If the Solution is Acceptable, Then Deploy Model(s) (as suggested by step or stage 110);
   If the performance is acceptable, then the bidding strategy is deployed; if the model performance is not acceptable, then control is passed to a process or element that is configured and operates to control the retraining (updating) of one or more of the Win-Rate and KPI models (as suggested by step or stage 120) and/or to control the generation of an updated Inventory Forecast (as suggested by step or stage 122);
      In one embodiment, retraining may include a feedback mechanism to provide the example of unacceptable performance to a machine learning algorithm that uses the example as part of its training data;
Deploy the Determined Bidding Strategy. Apply the Bid Price Function and use the Worth-to-Volume Ratio Threshold to Decide Whether to Submit a Bid or Not to Submit a Bid (as suggested by step or stage 112);
In one embodiment, a process may monitor bids and bid outcomes and compare those to expectations based on the Inventory Forecast (as suggested by step or stage 114);
   In this embodiment, logic may be executed to determine if the deviations from the expected values are “minor” (corresponding to the “Yes” branch of step or stage 116); if so, then a process may be executed to adjust the bid strategy parameters (as suggested by step or stage 118), after which the revised bidding strategy is deployed (as indicated by returning control to step or stage 112);
   In this embodiment, if the deviations from the expected values are not “minor” (corresponding to the “No” branch of step or stage 1116, then control is passed back to the model retraining and/or inventory forecast re-generation control (elements, components, or processes 120 and 122);
      The monitoring function or stages typically occur at regular intervals, so a check for the significance of a deviation would occur again one time-period later.

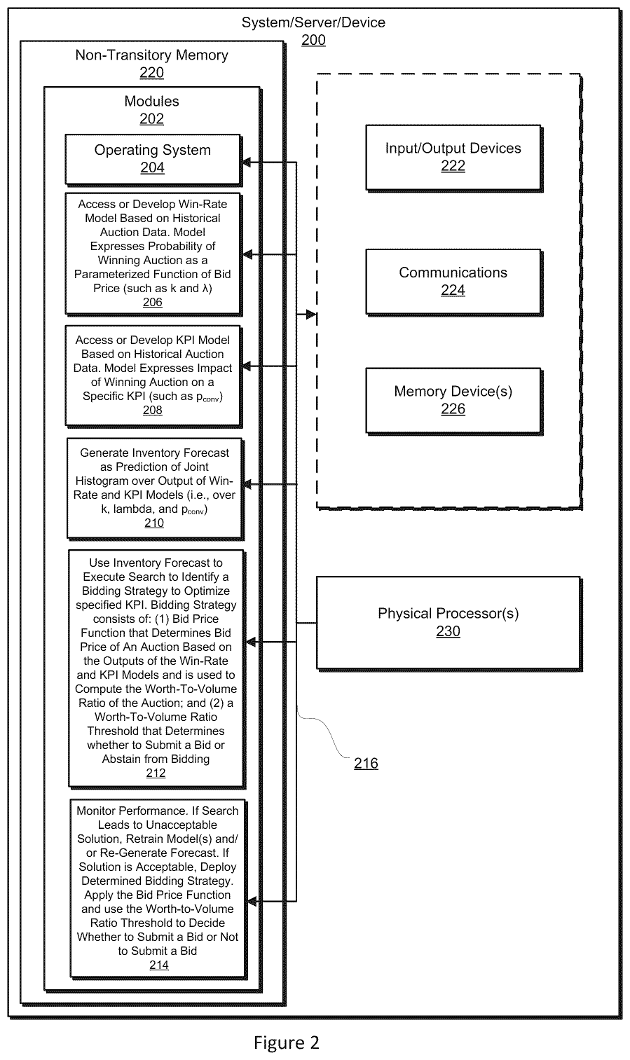

FIG. 2 is a diagram illustrating elements or components that may be present in a computing device, server, or system 200 configured to implement a method, process, function, or operation in accordance with some embodiments. As noted, in some embodiments, the disclosed and/or described system and methods may be implemented in the form of an apparatus that includes a processing element and set of computer-executable instructions. The executable instructions may be part of a software application and arranged into a software architecture.

In general, an embodiment may be implemented using a set of software instructions that are designed to be executed by a suitably programmed processing element (such as a GPU, CPU, microprocessor, processor, controller, state machine, or computing device, as non-limiting examples). In a complex application or system such instructions are typically arranged into “modules” with each such module (or sub-module) typically performing a specific task, process, function, or operation. The entire set of modules may be controlled or coordinated in their operation by an operating system (OS) or other form of organizational platform.

Each application module or sub-module may correspond to a particular function, method, process, or operation that is implemented by the module or sub-module. Such function, method, process, or operation may include those used to implement one or more aspects of the disclosed and/or described system and methods.

The application modules and/or sub-modules 202 may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

Modules 202 may contain one or more sets of instructions for performing a method or function described with reference to the Figures, and the disclosure and/or descriptions of the functions and operations provided in the specification. These modules may include those illustrated but may also include a greater number or fewer number than those illustrated.

As mentioned, each module may contain a set of computer-executable instructions. The set of instructions may be executed by a programmed processor contained in a server, client device, network element, system, platform, or other component. The computer-executable instructions that are contained in the modules or in a specific module or sub-module may be executed by the same processor or by different processors. Further, the computer-executable instructions that are contained in a single module may be executed (in whole or in part) by one processor or by more than one processor.

A module or sub-module may contain instructions that are executed by a processor contained in more than one of a server, client device, network element, system, platform, or other component. In some embodiments, a plurality of electronic processors, with each being part of a separate device, server, or system may be responsible for executing all or a portion of the software instructions contained in an illustrated module.

Thus, although FIG. 2 illustrates a set of modules which taken together perform multiple functions or operations, these functions or operations may be performed by different devices or system elements, with certain of the modules (or instructions contained in those modules) being associated with those devices or system elements.

As shown in FIG. 2, system 200 may represent a server or other form of computing or data processing system, platform, or device. Modules 202 each contain a set of computer-executable instructions, where when the set of instructions is executed by a suitable electronic processor or processors (such as that indicated in the figure by “Physical Processor(s) 230”), system (or server, platform, or device) 200 operates to perform a specific process, operation, function, or method.

Modules 202 are stored in a (non-transitory) memory 220, which typically includes an Operating System module 204 that contains instructions used (among other functions) to access and control the execution of the instructions contained in other modules. The modules 202 stored in memory 220 are accessed for purposes of transferring data and executing instructions by use of a “bus” or communications line 216, which also serves to permit processor(s) 230 to communicate with the modules for purposes of accessing and executing a set of instructions.

Bus or communications line 216 also permits processor(s) 230 to interact with other elements of system 200, such as input or output devices 222, communications elements 224 for exchanging data and information with devices external to system 200, and additional memory devices 226.

In some embodiments, the modules 202 may comprise computer-executable software instructions that when executed by one or more electronic processors cause the processors or a system or apparatus containing the processors to perform one or more of the steps or stages of:
Access or Develop a Win-Rate Model Based on Historical Auction Data. In one embodiment, the model expresses a probability of winning an auction as a function of the bid-price as a Weibull distribution parameterized by k and lambda (λ) (as suggested by module 206);
Access or Develop a KPI Model Based on Historical Auction Data. In one embodiment, the model expresses the impact of winning an auction on a specific KPI (p_{conv} as an example) (as suggested by module 208);
Generate an Inventory Forecast as a Prediction of a Joint Histogram over Outputs of the Win-Rate and KPI Models (i.e., over k, lambda (λ), and p_{conv},) (as suggested by module 210);
Use the Inventory Forecast to Execute a Search to Identify a Bidding Strategy to Optimize a specified KPI. A Bidding Strategy consists of: (1) a Bid Price Function that Determines the Bid Price of An Auction Based on the Outputs of the Win-Rate and KPI Models and which is used to Compute the Worth-To-Volume Ratio of the Auction; and (2) a Worth-To-Volume Ratio Threshold that determine whether to Submit a Bid or Abstain (as suggested module 212);
   In some embodiments, the search includes an outer process that searches over possible bid price functions, and an inner process that evaluates the performance of each bid price function using the inventory forecast;
Monitor Performance of the Model(s). If the Search Leads to an Unacceptable Solution, Retrain one or more of the models. If Solution is Acceptable, Deploy the Determined Bidding Strategy. Apply the Bid Price Function and use the Worth-to-Volume Ratio Threshold to Decide Whether to Submit a Bid or Not to Submit a Bid (as suggested by module 214);
   If the performance is acceptable, then the bidding strategy is deployed; if the model performance is not acceptable, then control is passed to a process or element that is configured and operates to control the retraining (updating) of one or more of the Win-Rate and KPI models and/or to control the generation of an updated Inventory Forecast;
      In one embodiment, retraining may include a feedback mechanism to provide the example of unacceptable performance to a machine learning algorithm that uses the example as part of its training data;
   In some embodiments, deployment may involve one or more of the following steps, stages, operations, functions, or processes (using the assumed KPI and heuristic):
      Deployed in a DSP—in this setting, when the bid-request is received by the DSP one or more of the following steps may be implemented:
         1) the bid-request is mapped to a set of features using an online feature store;
         2) the win-rate and KPI models are executed;
         3) the bid-price is calculated using the function F and the parameters theta (θ) selected in the strategy search process;
         4) the worth-to-volume ratio is computed; and
         5) if the computed ratio exceeds the threshold value, then bid. Else don't bid.
            These steps are typically executed with a latency of a few milliseconds for every bid-request that meets the criteria necessary for the tactic (and, in some cases, up to millions of times per second). Alternatively, the same (or equivalent) logic can be used to label bid-requests rather than bid directly on an auction. For example, bid-requests can be added to specific DealIDs or Private Marketplaces based on the bid-price and worth-to-volume ratio that results from the steps disclosed and/or described herein.

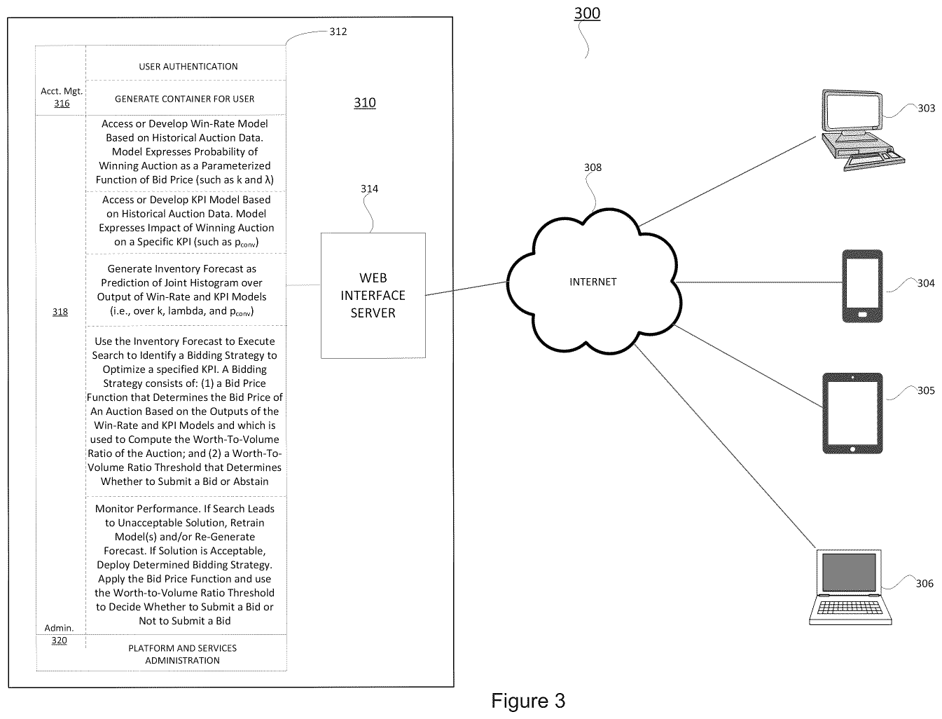

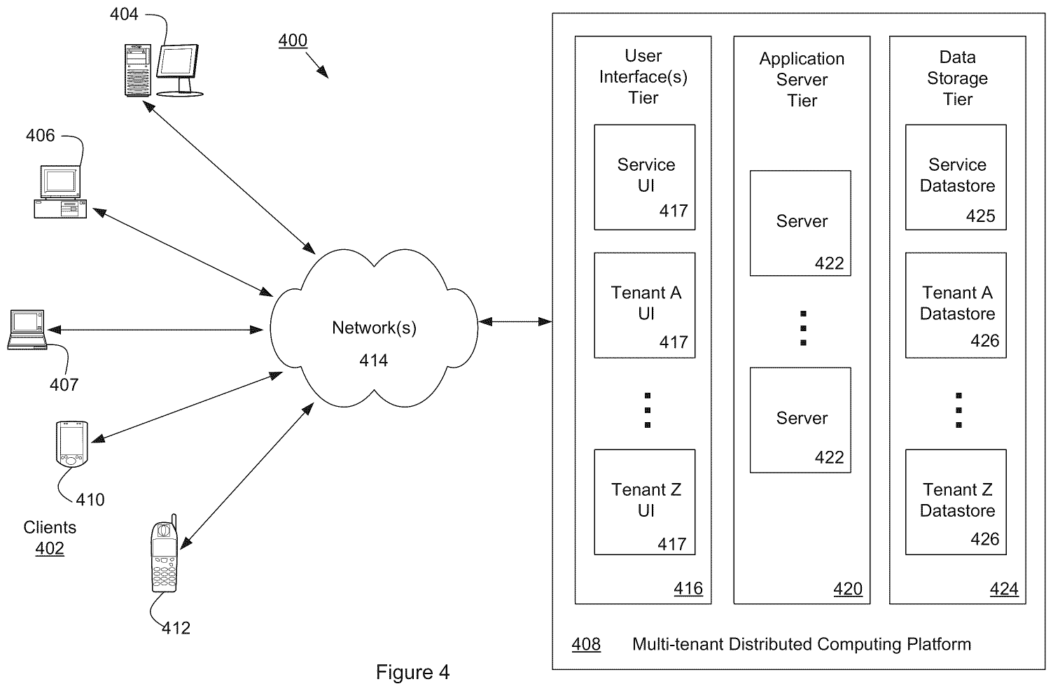

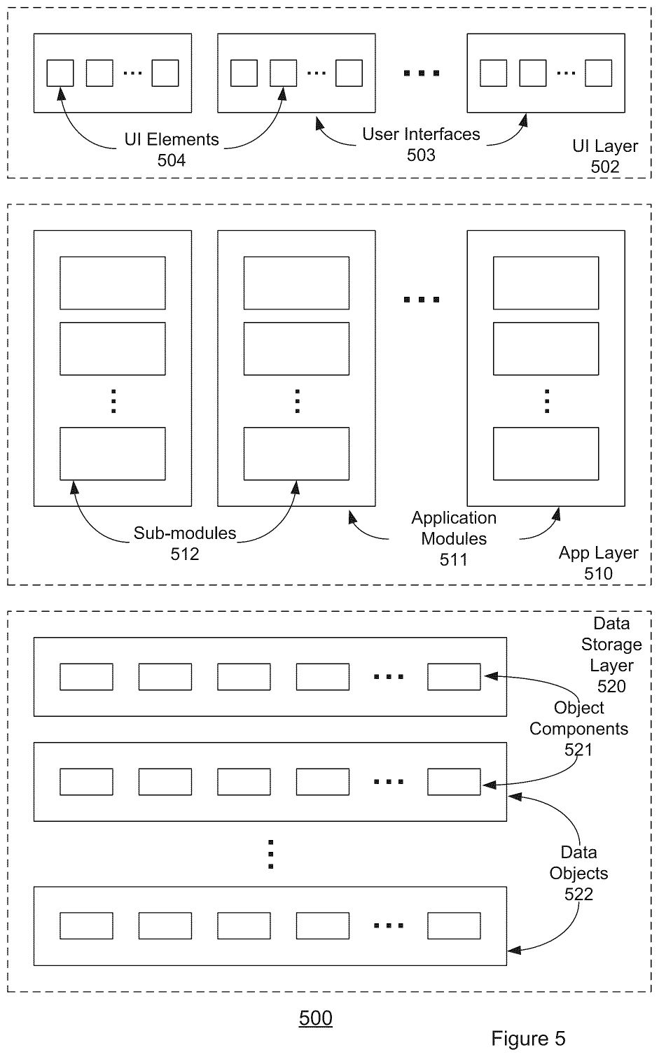

In some embodiments, the functionality and services provided by the system, apparatuses, and methods disclosed and/or described herein may be made available to multiple users by accessing an account maintained by a server or service platform. Such a server or service platform may be termed a form of Software-as-a-Service (SaaS). FIGS. 3, 4, and 5 are diagrams illustrating an architecture for a multi-tenant or SaaS platform that may be used in implementing an embodiment of the systems, apparatuses, and methods. FIG. 3 is a diagram illustrating a SaaS system with which an embodiment may be implemented. FIG. 4 is a diagram illustrating elements or components of an example operating environment with which an embodiment may be implemented. FIG. 5 is a diagram illustrating additional details of the elements or components of the multi-tenant distributed computing service platform of FIG. 4, with which an embodiment may be implemented.

In some embodiments, the system or services disclosed and/or described herein for determining and executing an optimal bidding strategy may be implemented as microservices, processes, workflows or functions performed in response to the submission of a set of input data. The microservices, processes, workflows or functions may be performed by a server, data processing element, platform, or system.

In some embodiments, the data processing and other services may be provided by a service platform located “in the cloud”. In such embodiments, the platform may be accessible through APIs and SDKs. The functions, processes and capabilities disclosed and/or described herein (and in some cases, with reference to one or more of the Figures) may be provided as microservices within the platform. The interfaces to the microservices may be defined by REST and GraphQL endpoints. An administrative console may allow users or an administrator to securely access the underlying request and response data, manage accounts and access, and in some cases, modify the processing workflow or configuration.

Note that although FIGS. 3, 4, and 5 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide one or more of the processes, functions, features, or operations disclosed and/or described herein.

In some embodiments, a platform or system of the type illustrated in the Figures and disclosed and/or described herein may be operated by an entity that provides a specific set of services or applications. In other embodiments, the platform may be operated by a first entity and a different entity may provide the applications or services for users through the platform.

FIG. 3 is a diagram illustrating a system 300 with which an embodiment may be implemented or through which an embodiment of the services disclosed and/or described herein may be accessed. In accordance with the advantages of an application service provider (ASP) hosted business service system (such as a multi-tenant data processing platform), users of the services may comprise individuals, businesses, or organizations, as non-limiting examples.

A user may access the services using a suitable client. In general, a client device having access to the Internet may be used to provide data to the platform for processing and evaluation and/or obtain an output or execute a strategy based on the data processing. A user interfaces with the service platform across the Internet 308 or another suitable communications network or combination of networks. Examples of suitable client devices include desktop computers 303, smartphones 304, tablet computers 305, or laptop computers 306.

System 310 may include a set of data analysis and other services to assist in determining and/or executing an optimal bidding strategy for online repeated first price auctions 312, and a web interface server 314, coupled as shown in FIG. 3. It is to be appreciated that either or both the data analysis and other services 312 and the web interface server 314 may be implemented on one or more different hardware systems and components, even though represented as singular units in FIG. 3. Services 312 may include one or more functions or operations for the processing of data and development of models to generate and/or execute an optimal bidding strategy.

As examples, in some embodiments, the set of functions, operations or services made available through the platform or system 310 may include:
Account Management services 316, such as:
   a process or service to authenticate a user;
   a process or service to generate a container or instantiation of the data analysis and network evaluation services for that user;
Data Processing services 318, such as a process or service to:
   Access or Develop a Win-Rate Model Based on Historical Auction Data. In one embodiment, the model expresses a probability of winning an auction as a function of the bid-price as a Weibull distribution parameterized by k and lambda (λ);
   Access or Develop a KPI Model Based on Historical Auction Data. In one embodiment, the model Expresses the Impact of Winning an Auction on a Specific KPI (e.g., p_{conv} or other KPI);
   Generate an Inventory Forecast as a Prediction of a Joint Histogram over the Output of the Win-Rate and KPI Models (i.e., over k, lambda (λ), and p_{conv});
   Use the Inventory Forecast to Execute a Search to Identify a Bidding Strategy to Optimize a specified KPI. A Bidding Strategy consists of: (1) a Bid Price Function that Determines the Bid Price of An Auction Based on the Outputs of the Win-Rate and KPI Models and which is used to Compute the Worth-To-Volume Ratio of the Auction; and (2) a Worth-To-Volume Ratio Threshold that determine whether to Submit a Bid or Abstain from Bidding;
      In one embodiment, the Search Includes an Outer Process that Searches over Possible Bid Price Functions, and an Inner Process that Evaluates the Performance of Each Bid Price Function Using the Inventory Forecast;
   Monitor Performance of the Model(s). If the Search Leads to an Unacceptable Solution, Retrain one or more of the models. If the Solution is Acceptable, Deploy the Determined Bidding Strategy. Apply the Bid Price Function and use the Worth-to-Volume Ratio Threshold to Decide Whether to Submit a Bid or Not to Submit a Bid;
Administrative services 320, such as:
   a process or services to provide platform and services administration—for example, to enable the provider of the services and/or the platform to administer and configure the processes and services provided to users.

The platform or system shown in FIG. 3 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, or web server.

FIG. 4 is a diagram illustrating elements or components of an example operating environment 400 with which an embodiment may be implemented. As shown, a variety of clients 402 incorporating and/or incorporated into a variety of computing devices may communicate with a multi-tenant service platform 408 through one or more networks 414. For example, a client may incorporate and/or be incorporated into a client application (e.g., software) implemented at least in part by one or more of the computing devices.

Examples of suitable computing devices include personal computers, server computers 404, desktop computers 406, laptop computers 407, notebook computers, tablet computers or personal digital assistants (PDAs) 410, smart phones 412, cell phones, and consumer electronic devices incorporating one or more computing device components, such as one or more electronic processors, microprocessors, central processing units (CPU), or controllers. Examples of suitable networks 414 include networks utilizing wired and/or wireless communication technologies and networks operating in accordance with any suitable networking and/or communication protocol (e.g., the Internet).

The distributed computing service/platform (which may also be referred to as a multi-tenant data processing platform) 408 may include multiple processing tiers, including a user interface tier 416, an application server tier 420, and a data storage tier 424. The user interface tier 416 may maintain multiple user interfaces 417, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant or platform administrator to administer the tenant's access to and use of the functions and capabilities provided by the service platform. This may include accessing tenant data, launching an instantiation of a specific application, or causing the execution of specific data processing operations.

Each application server or processing tier 422 shown in the figure may be implemented with a set of computers and/or components including computer servers and processors, and may perform various functions, methods, processes, or operations as determined by the execution of a software application or set of instructions. The data storage tier 424 may include one or more data stores, which may include a Service Data store 425 and one or more Tenant Data stores 426. Data stores may be implemented with any suitable data storage technology, including structured query language (SQL) based relational database management systems (RDBMS).

Service Platform 408 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information.

Such functions or applications are typically implemented by one or more modules of software code/instructions that are maintained on and executed by one or more servers 422 that are part of the platform's Application Server Tier 420. As noted with regards to FIG. 3, the platform system shown in FIG. 4 may be hosted on a distributed computing system made up of at least one, but typically multiple, “servers.”

As mentioned, rather than build and maintain such a platform or system themselves, a business may utilize systems provided by a different entity (such as a third party). An entity may implement a business system/platform in the context of a multi-tenant platform, where individual instantiations of one or more data processing workflow(s) (such as the data analysis and generation and/or execution of an optimal bidding strategy services disclosed and/or described herein) are provided to multiple users, with each business (such as an advertiser or DSP) representing a tenant of the platform.

An advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 5 is a diagram illustrating additional details of the elements or components of the multi-tenant distributed computing service platform of FIG. 4, with which an embodiment may be implemented. In general, an embodiment may be implemented using a set of software instructions that are designed to be executed by a suitably programmed processing element (such as a CPU, microprocessor, processor, controller, state machine, or computing device, as non-limiting examples). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 5 is a diagram illustrating additional details of the elements or components 500 of a multi-tenant distributed computing service platform, with which an embodiment may be implemented. The example architecture includes a user interface layer or tier 502 having one or more user interfaces 503. Examples of such user interfaces include graphical user interfaces and application programming interfaces (APIs). Each user interface may include one or more interface elements 504. For example, users may interact with interface elements to access functionality and/or data provided by application and/or data storage layers of the example architecture.

Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 510 may include one or more application modules 511, each having one or more sub-modules 512. Each application module 511 or sub-module 512 may correspond to a function, method, process, or operation that is implemented by the module or sub-module (e.g., a function or process related to providing data processing and services to a user of the platform). Such function, method, process, or operation may include those used to implement one or more aspects of the disclosed and/or described systems and methods, such as for one or more of the processes or functions described with reference to the Figures:
Access or Develop a Win-Rate Model Based on Historical Auction Data. In one embodiment, the model expresses a probability of winning an auction as a function of the bid-price as a Weibull distribution parameterized by k and lambda (λ);
Access or Develop a KPI Model Based on Historical Auction Data. In one embodiment, the model Expresses the Impact of Winning an Auction on a Specific KPI (e.g., p_{conv} or other KPI);
Generate an Inventory Forecast as a Prediction of a Joint Histogram over Output of Win-Rate and KPI Models (i.e., over k, lambda (λ), and p_{conv});
Use the Inventory Forecast to Execute a Search to Identify a Bidding Strategy to Optimize a specified KPI. A Bidding Strategy consists of: (1) a Bid Price Function that Determines the Bid Price of An Auction Based on the Outputs of the Win-Rate and KPI Models and which is used to Compute the Worth-To-Volume Ratio of the Auction; and (2) a Worth-To-Volume Ratio Threshold that determine whether to Submit a Bid or Abstain;
   In one embodiment, the Search Includes an Outer Process that Searches over Possible Bid Price Functions, and an Inner Process that Evaluates the Performance of Each Bid Function;
Monitor Performance of the Model(s). If the Search Leads to an Unacceptable Solution, Retrain one or more of the models. If the Solution is Acceptable, Deploy the Determined Bidding Strategy. Apply the Bid Price Function and use the Worth-to-Volume Ratio Threshold to Decide Whether to Submit a Bid or Not to Submit a Bid.

The application modules and/or sub-modules may include a suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language.

Each application server (e.g., as represented by element 422 of FIG. 4) may include each application module. Alternatively, different application servers may include different sets of application modules. Such sets may be disjoint or overlapping.

The data storage layer 520 may include one or more data objects 522 each having one or more data object components 521, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3, 4, and 5 are not intended to be limiting examples. Further environments in which an embodiment may be implemented in whole or in part include devices (including mobile devices), software applications, systems, apparatuses, networks, SaaS platforms, IaaS (infrastructure-as-a-service) platforms, or other configurable components that may be used by multiple users for one or more of data entry, data processing, application execution, or data review.

The disclosure includes the following clauses and embodiments:

1. A method of generating a bidding strategy for a repeated first price auction, comprising:
access a win-rate model based on historical auction data, wherein the win-rate model expresses a probability of winning an auction as a function of a bid-price;
access a KPI model based on historical auction data, wherein the KPI the model expresses an impact of winning an auction on a specific KPI;
generate an inventory forecast as a prediction of a joint histogram over the outputs of the win-rate and KPI models;
execute a search process to identify a bidding strategy that determines which auctions to bid on and at what bid prices to bid to optimize the KPI; and
deploy the identified bidding strategy, wherein the bidding strategy includes a bid price function that determines the bid price of an auction based on the outputs of the win-rate and KPI models, a worth-to-volume ratio of the auction, and a worth-to-volume ratio threshold that determines whether to submit a bid or abstain from bidding.

2. The method of clause 1, wherein the worth-to-volume ratio of the auction is a ratio of the KPI to the bid price for the auction.

3. The method of clause 1, wherein the search includes an outer process that searches over possible bid functions, and an inner process that evaluates a performance of each bid function.

4. The method of clause 1, wherein the win-rate model is developed by applying a machine learning algorithm to at least a portion of the historical auction data.

5. The method of clause 1, wherein the KPI model is developed by applying a machine learning algorithm to at least a portion of the historical auction data.

6. The method of clause 5, wherein the KPI model is developed using a probability of conversion as the KPI.

7. The method of clause 1, wherein the inventory forecast is a prediction about the distribution of win-rate and KPI-model outputs that is expected to be observed on future auctions based on the historical auction data.

8. The method of clause 1, wherein the inventory forecast is used to simulate the performance of defined bidding strategies, and a set of parameters that lead to a best simulated performance are selected.

9. The method of clause 8, wherein a strategy is deployed using the selected parameters to determine a bid price and whether to submit a bid or not to submit a bid on an auction, in an online and substantially real-time fashion.

10. The method of clause 1, wherein the win-rate model based on historical auction expresses a probability of winning an auction as a function of the bid-price as a Weibull distribution parameterized by k and lambda (λ), where k represents a shape parameter and λ represents a scale parameter of the distribution.

11. The method of clause 1, wherein the specific KPI is a combination of more than a single KPI, and the KPI model is used to generate a value of winning an auction for each of the KPIs in the combination.

12. The method of clause 1, further comprising monitoring performance of one or more of the win-rate model and KPI model, wherein if the performance is acceptable the determined strategy is deployed, and wherein if the performance is not acceptable, then control is passed to a process or element that is configured and operates to control the retraining of one or more of the win-rate and KPI models or to control the generation of an updated inventory forecast.

13. A system, comprising:
one or more electronic processors configured to execute a set of computer-executable instructions; and
one or more non-transitory electronic data storage media containing the set of computer-executable instructions, wherein when executed, the instructions cause the one or more electronic processors to
   access a win-rate model based on historical auction data, wherein the win-rate model expresses a probability of winning an auction as a function of a bid-price;
   access a KPI model based on historical auction data, wherein the KPI the model expresses an impact of winning an auction on a specific KPI;
   generate an inventory forecast as a prediction of a joint histogram over the outputs of the win-rate and KPI models;
   execute a search process to identify a bidding strategy that determines which auctions to bid on and at what bid prices to bid to optimize the KPI; and
   deploy the identified bidding strategy, wherein the bidding strategy includes a bid price function that determines the bid price of an auction based on the outputs of the win-rate and KPI models, a worth-to-volume ratio of the auction, and a worth-to-volume ratio threshold that determines whether to submit a bid or abstain from bidding.

14. One or more non-transitory computer-readable media comprising a set of computer-executable instructions that when executed by one or more programmed electronic processors, cause the processors to
access a win-rate model based on historical auction data, wherein the win-rate model expresses a probability of winning an auction as a function of a bid-price;
access a KPI model based on historical auction data, wherein the KPI the model expresses an impact of winning an auction on a specific KPI;
generate an inventory forecast as a prediction of a joint histogram over the outputs of the win-rate and KPI models;
execute a search process to identify a bidding strategy that determines which auctions to bid on and at what bid prices to bid to optimize the KPI; and
deploy the identified bidding strategy, wherein the bidding strategy includes a bid price function that determines the bid price of an auction based on the outputs of the win-rate and KPI models, a worth-to-volume ratio of the auction, and a worth-to-volume ratio threshold that determines whether to submit a bid or abstain from bidding.

The embodiments disclosed and/or described herein can be implemented in the form of control logic using computer software in a modular or integrated manner. Based on the disclosure and teachings provided herein, a person of ordinary skill in the art will know and appreciate other ways and/or methods to implement one or more embodiments using hardware and a combination of hardware and software.

In some embodiments, certain of the methods, models, or functions disclosed and/or described herein may be embodied in the form of a trained neural network or machine learning (ML) model, where the network or model is implemented by execution of a set of computer-executable instructions or other means. The set of instructions may be stored in (or on) a non-transitory computer-readable medium and executed by a programmed processor or processing element.

The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. The specific form of the method, model, or function may be used to define one or more of the operations, functions, processes, or methods used in the development, training, or operation of a neural network, the application of a machine learning technique or techniques, or the development or implementation of an appropriate decision process.

Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” that exchange messages between each other. The connections have numeric weights that are “tuned” during a training process, so that a properly trained network will respond correctly when presented with an image or pattern to recognize (for example).

In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training may use general-purpose methods to iteratively determine the weights for intermediate and final feature neurons. In terms of a computational model, each neuron may calculate the dot product of inputs and weights, add the bias, and apply a non-linear trigger or activation function (for example, a sigmoid response function).

A machine learning model is a set of layers of connected neurons that operate to infer or generate a decision (such as a classification) regarding a sample of input data. A model is typically trained by inputting multiple examples of input data and an associated correct “response” or decision regarding each set of input data. Thus, each input data example is associated with a label or other indicator of the correct response that a properly trained model should generate. The examples and labels are input to the model for purposes of training the model. When trained (i.e., the weights connecting neurons have converged and become stable or within an acceptable amount of variation), the model will operate to respond to an input sample of data to generate the “correct” label or classification as an output.

In this regard and as non-limiting examples, the F function(s) could be implemented as a Neural Network (NN). The win-rate model and KPI model may be implemented as neural networks, and the advanced time-series forecasting method based on inventory forecasting could also be based on a neural network or networks.

In some examples, a neural network may be implemented based on multiple and/or different types of topologies and/or architectures including deep neural networks with fully connected (e.g., dense) layers, Long Short-Term Memory (LSTM) layers, convolutional layers, Temporal Convolutional Layers (TCL), other suitable types of deep neural network topology and/or architectures, or a combination thereof.

A neural network may have different types of output layers including, without limitation, output layers with logistic sigmoid activation functions, hyperbolic tangent activation functions, linear units, rectified linear units, other suitable types of nonlinear units, or a combination thereof. In some examples, a neural network may be configured to represent the probability distribution over a model or models.

One or more of the software components, processes or functions disclosed and/or described may be implemented as software code to be executed by a processor using any suitable computer language such as Python, Java, JavaScript, C++, or Perl using conventional or object-oriented techniques. The software code may be stored as a series of instructions, or commands in (or on) a non-transitory computer-readable medium, such as a random-access memory (RAM), a read only memory (ROM), a magnetic medium such as a hard-drive, or an optical medium such as a CD-ROM.

In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network. Further, the set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a flash memory, a USB flash drive, an external hard disk drive, thumb drive, pen drive, key drive, a High-Density Digital Versatile Disc (HDDVD) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies.

Such computer-readable storage media allow the processing element or processor to access computer-executable process steps and application programs stored on removable and non-removable memory media, to off-load data from a device, or to upload data to a device. As mentioned with regards to the embodiments disclosed and/or described herein, a non-transitory computer-readable medium may include almost any structure, technology, or method apart from a transitory waveform or similar medium.

Certain implementations of the disclosed technology are described herein with reference to block diagrams of systems, and/or to flowcharts or flow diagrams of functions, operations, processes, or methods. It should be understood that one or more blocks of the block diagrams, or one or more stages or steps of the flowcharts or flow diagrams, and combinations of blocks in the block diagrams and stages or steps of the flowcharts or flow diagrams, respectively, can be implemented by computer-executable program instructions. Note that in some embodiments, one or more of the blocks, or stages or steps may not necessarily need to be performed in the order presented or may not necessarily need to be performed at all.

The computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. The computer program instructions may also be stored in a computer-readable memory that can direct a computer or other programmable data processing apparatus to function in a specific manner, such that the instructions stored in the computer-readable memory produce an article of manufacture including instruction means that implement one or more of the functions, operations, processes, or methods disclosed and/or described herein.

While certain implementations of the disclosed technology have been described in connection with what is presently considered to be the most practical and various implementations, it should be understood that the disclosure is not limited to the described implementations. Instead, the disclosure is intended to cover various modifications and equivalent arrangements included within the scope of the appended claims. Although specific terms are employed herein, they are used in a generic and descriptive sense only and not for purposes of limitation.

This written description uses examples to describe certain implementations of the disclosure, and to enable a person skilled in the art to practice certain implementations of the same, including making and using devices or systems and performing the incorporated methods. The patentable scope of certain implementations of the disclosure is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar references in the specification and in the following claims are to be construed to cover both the singular and the plural, unless otherwise indicated herein or clearly contradicted by context. The terms “having,” “including,” “containing” and similar references in the specification and in the claims are to be construed as open-ended terms (e.g., meaning “including, but not limited to,”) unless otherwise noted.

Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context.

The use of all examples, or exemplary language (e.g., “such as”) provided herein, is intended merely to better illuminate embodiments of the disclosure, and do not pose a limitation to the scope of the invention unless otherwise claimed. No language in the specification should be construed as indicating any non-claimed element as essential to each embodiment of the disclosure.

As used herein in the specification, figures, and claims, the term “or” is used inclusively to refer items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of the disclosure. Accordingly, the disclosure is not limited to the embodiments described or depicted in the drawings, and various embodiments and modifications can be made without departing from the scope of the claims below.

1. A method of generating a bidding strategy for a repeated first price auction, comprising:
access a win-rate model based on historical auction data, wherein the win-rate model expresses a probability of winning an auction as a function of a bid-price;
access a KPI model based on historical auction data, wherein the KPI the model expresses an impact of winning an auction on a specific KPI;
generate an inventory forecast as a prediction of a joint histogram over the outputs of the win-rate and KPI models;
execute a search process to identify a bidding strategy that determines which auctions to bid on and at what bid prices to bid to optimize the KPI; and
deploy the identified bidding strategy, wherein the bidding strategy includes a bid price function that determines the bid price of an auction based on the outputs of the win-rate and KPI models, a worth-to-volume ratio of the auction, and a worth-to-volume ratio threshold that determines whether to submit a bid or abstain from bidding.

2. The method of claim 1, wherein the worth-to-volume ratio of the auction is a ratio of the KPI to the bid price for the auction.

3. The method of claim 1, wherein the search includes an outer process that searches over possible bid functions, and an inner process that evaluates a performance of each bid function.

4. The method of claim 1, wherein the win-rate model is developed by applying a machine learning algorithm to at least a portion of the historical auction data.

5. The method of claim 1, wherein the KPI model is developed by applying a machine learning algorithm to at least a portion of the historical auction data.

6. The method of claim 5, wherein the KPI model is developed using a probability of conversion as the KPI.

7. The method of claim 1, wherein the inventory forecast is a prediction about the distribution of win-rate and KPI-model outputs that is expected to be observed on future auctions based on the historical auction data.

8. The method of claim 1, wherein the inventory forecast is used to simulate the performance of parametrically defined bidding strategies, and a set of parameters that lead to a best simulated performance are selected.

9. The method of claim 8, wherein a strategy is deployed using the selected parameters to determine a bid price and whether to submit a bid or not to submit a bid on an auction, in an online and substantially real-time fashion.

10. The method of claim 1, wherein the win-rate model based on historical auction expresses a probability of winning an auction as a function of the bid-price as a Weibull distribution parameterized by k and lambda (λ), where k represents a shape parameter and λ represents a scale parameter of the distribution.

11. The method of claim 1, wherein the specific KPI is a combination of more than a single KPI, and the KPI model is used to generate a value of winning an auction for each of the KPIs in the combination.

12. The method of claim 1, further comprising monitoring performance of one or more of the win-rate model and KPI model, wherein if the performance is acceptable the determined strategy is deployed, and wherein if the performance is not acceptable, then control is passed to a process or element that is configured and operates to control the retraining of one or more of the win-rate and KPI models or to control the generation of an updated inventory forecast.

13. A system, comprising:
one or more electronic processors configured to execute a set of computer-executable instructions; and
one or more non-transitory electronic data storage media containing the set of computer-executable instructions, wherein when executed, the instructions cause the one or more electronic processors to
access a win-rate model based on historical auction data, wherein the win-rate model expresses a probability of winning an auction as a function of a bid-price;
access a KPI model based on historical auction data, wherein the KPI the model expresses an impact of winning an auction on a specific KPI;
generate an inventory forecast as a prediction of a joint histogram over the outputs of the win-rate and KPI models;
execute a search process to identify a bidding strategy that determines which auctions to bid on and at what bid prices to bid to optimize the KPI; and
deploy the identified bidding strategy, wherein the bidding strategy includes a bid price function that determines the bid price of an auction based on the outputs of the win-rate and KPI models, a worth-to-volume ratio of the auction, and a worth-to-volume ratio threshold that determines whether to submit a bid or abstain from bidding.

14. The system of claim 13, wherein the worth-to-volume ratio of the auction is a ratio of the KPI to the bid price for the auction.

15. The system of claim 13, wherein the search includes an outer process that searches over possible bid functions and an inner process that evaluates a performance of each bid function, the win-rate model is developed by applying a machine learning algorithm to at least a portion of the historical auction data, the KPI model is developed by applying a machine learning algorithm to at least a portion of the historical auction data, and the KPI model is developed using a probability of conversion as the KPI.

16. The system of claim 13, wherein the win-rate model based on historical auction expresses a probability of winning an auction as a function of the bid-price as a Weibull distribution parameterized by k and lambda (λ), where k represents a shape parameter and λ represents a scale parameter of the distribution.

17. One or more non-transitory computer-readable media comprising a set of computer-executable instructions that when executed by one or more programmed electronic processors, cause the processors to
access a win-rate model based on historical auction data, wherein the win-rate model expresses a probability of winning an auction as a function of a bid-price;
access a KPI model based on historical auction data, wherein the KPI the model expresses an impact of winning an auction on a specific KPI;
generate an inventory forecast as a prediction of a joint histogram over the outputs of the win-rate and KPI models;
execute a search process to identify a bidding strategy that determines which auctions to bid on and at what bid prices to bid to optimize the KPI; and
deploy the identified bidding strategy, wherein the bidding strategy includes a bid price function that determines the bid price of an auction based on the outputs of the win-rate and KPI models, a worth-to-volume ratio of the auction, and a worth-to-volume ratio threshold that determines whether to submit a bid or abstain from bidding.

18. The one or more non-transitory computer-readable media of claim 17, wherein the worth-to-volume ratio of the auction is a ratio of the KPI to the bid price for the auction.

19. The one or more non-transitory computer-readable media of claim 17, wherein the search includes an outer process that searches over possible bid functions and an inner process that evaluates a performance of each bid function, the win-rate model is developed by applying a machine learning algorithm to at least a portion of the historical auction data, the KPI model is developed by applying a machine learning algorithm to at least a portion of the historical auction data, and the KPI model is developed using a probability of conversion as the KPI.

20. The one or more non-transitory computer-readable media of claim 17, wherein the win-rate model based on historical auction expresses a probability of winning an auction as a function of the bid-price as a Weibull distribution parameterized by k and lambda (λ), where k represents a shape parameter and λ represents a scale parameter of the distribution.
